(19) United States
(12) Patent Application Publication
(10) Pub. No.: US 2007/0228192 A1
(43) Pub. Date: Oct. 4, 2007

(54) Fuel injector and production method

(75) Inventors: Masato Kumagai, Saitama (JP); Hiroshi Okada, Gunma (JP); Hiroshi Yamada, Gunma (JP); Yasuhiro Motegi, Gunma (JP)

Correspondence Address: FOLEY AND LARDNER LLP;SUITE 500, 3000 K STREET NW, WASHINGTON, DC, 20007, US

(73) Assignee: HITACHI , LTD.

(21) Appl. No.: 11/715,449

(22) Filed: Mar. 8, 2007

(30) Foreign Application Priority Data
Mar. 15, 2006 (JP) 2006-071475

(51) Int. Cl. F02M 63/00

(52) U.S. Cl. 239/533.2

(57) ABSTRACT

A fuel injector includes a valve seat member formed with a valve seat and a valve element including an abutting portion to abut on an abutting portion of the valve seat. One of the abutting portions of the valve seat and the valve element includes a surface layer which is softened by heat treatment, and which is pressed by abutment between the valve seat and the valve element.

### BACKGROUND OF THE INVENTION

The present invention relates to a fuel injector for an internal combustion engine, and a production method of producing a fuel injector.

A Japanese patent document JP 2000-145589A shows a fuel injector including a valve seat member formed with a valve seat; a movable valve element arranged to abut on the valve seat to close a valve and to move away from the valve seat to open the valve; a biasing device for urging the valve element to a valve closing direction; and an electromagnetic coil for moving the valve element away from the valve seat with a magnetic attractive force. The fuel injector injects fuel when the electromagnetic coil is energized and the valve element is forced away from the valve seat. When the electromagnetic coil is deenergized, the valve element is seated on the valve seat by the force of the biasing device, and stops the fuel injection.

Recently, from the viewpoint of protection of the environment, stricter requirement is imposed on the fuel injector of this kind for fuel sealing performance in the valve closing state. In order to improve the sealing performance, earlier technology employs measures of improving the machining accuracy to lower the surface roughness of the valve element and/or valve seat, or measures of repeating the valve opening and closing operation many times after the assembly of fuel injector to adapt the valve element and valve seat to fit to each other.

### SUMMARY OF THE INVENTION

However, the process for improving the machining accuracy requires troublesome operations and increases the manufacturing cost. Moreover, when welding is needed after a working operation, strain caused by welding makes it difficult to improve the sealing performance satisfactorily.

On the other hand, in order to improve the sealing performance sufficient, it is necessary to increase the number of repetitions of the valve opening and closing operation after the assembly, so that the manufacturing cost and time are increased.

It is therefore an object of the present invention to provide the construction and/or production method for a fuel injector suitable for improving the sealing performance.

According to one aspect of the invention, a fuel injector comprises: a valve seat member formed with a valve seat including an abutting portion; and a valve element which is arranged to abut on the valve seat and move away from the valve seat, and which includes an abutting portion to abut on the abutting portion of the valve seat. One of the abutting portions of the valve seat and the valve element includes a surface layer softened by heating the surface layer, and pressed by abutment between the valve element and the valve seat to each other to make the abutting portions to fit each other.

According to another aspect of the present invention, a production method of producing a fuel injector including a valve seat member which is formed with a valve seat including an abutting portion, and a valve element which is arranged to abut on the valve seat and to move away from the valve seat and which includes an abutting portion to abut on the abutting portion of the valve seat, comprises: softening a surface layer of one of the abutting portions of the valve seat and the valve element, by heating the surface layer; and then, adapting the abutting portions of the valve seat and the valve element to fit each other by pressing the valve element and the valve seat to each other.

### BRIEF DESCRIPTION OF THE DRAWINGS

FIG. 1 is a longitudinal sectional view of a fuel injector according to one embodiment of the present invention (as if cut by a plane containing an axis of the fuel injector).

FIG. 2 is a longitudinal sectional view of a forward end portion of the fuel injector shown in FIG. 1 in a seated state (valve closing state).

FIG. 3 is a flowchart showing a method for producing the fuel injector of FIG. 1 so as to improve the sealing performance.

FIGS. 4A and 4B are schematic views partially in section, for illustrating a softening operation at a step S13 of FIG. 3.

FIG. 5 is a graphic view showing the hardness (Vickers hardness) with respect to the depth from the surface of a valve seat member after the softening operation.

### DETAILED DESCRIPTION OF THE INVENTION

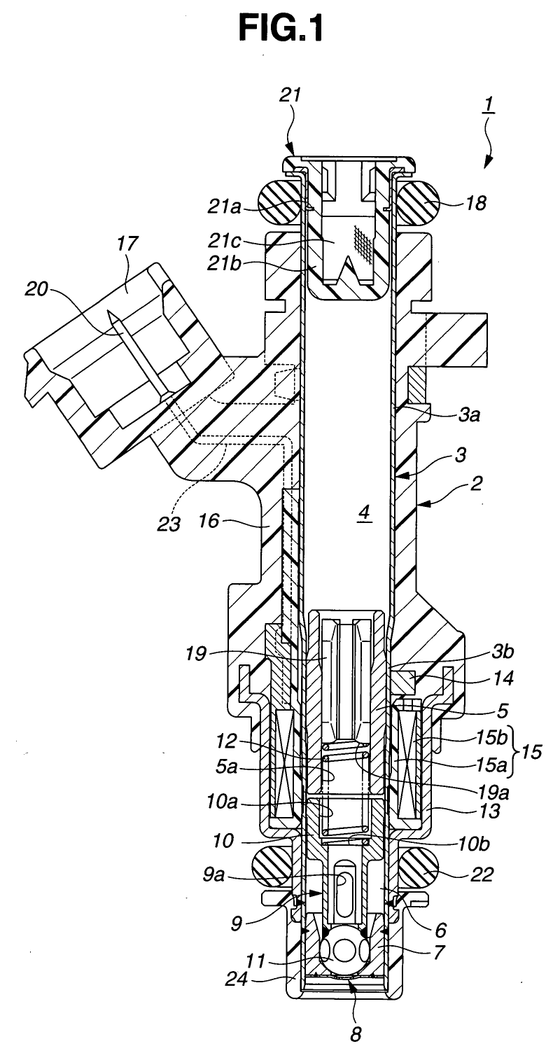

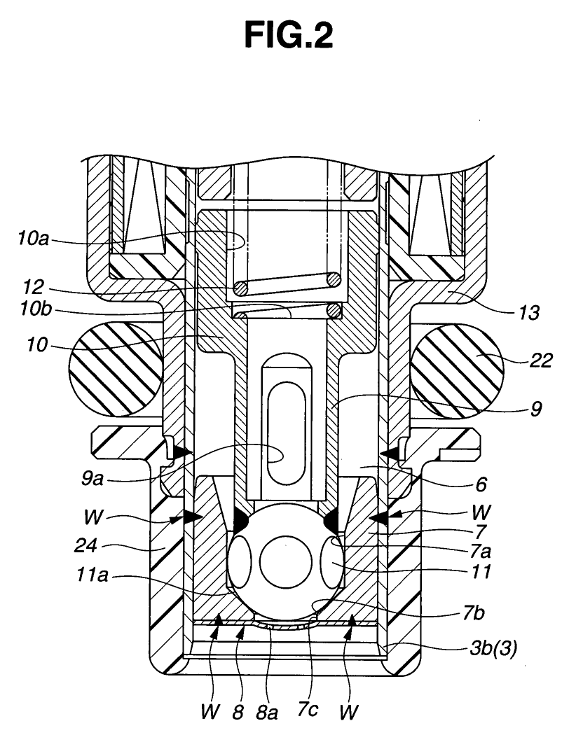

FIG. 1 shows a fuel injector or fuel injection valve according to one embodiment of the present invention in a longitudinal section as if it would appear if cut by an intersecting plane containing the axis of the fuel injector. FIG. 2 shows, in a longitudinal section, a forward end portion of the fuel injector in a seated state or valve closing state.

The fuel injector 1 shown in FIG. 1 is a fuel injector for an internal combustion engine. Fuel injector 1 is adapted to be connected with a boss portion of a fuel pipe, and to inject fuel supplied through the fuel pipe, into an internal combustion engine (into an intake port or directly into a cylinder).

As shown in FIG. 1, fuel injector 1 includes a main body composed of a casing 2, a magnetic tube member 3, a core tube 5, a yoke 13 and a resin cover 16.

Magnetic tube member 3 of this example is a stepped thin-wall metal tube of a magnetic material such as stainless material or stainless alloy, formed by press forming such as deep drawing. Magnetic tube member 3 of this example extends axially from a first end (upper end or upstream end) to a second end (lower end or downstream end), and includes a large diameter section 3a extending from the first end toward the second end and a small diameter section 3b extending from the second end to a step formed between the large and small diameter sections 3a and 3b. The first (upstream) end of tube member 3 is adapted to be inserted in a boss portion of a fuel pipe and thereby connected with the fuel pipe.

An O-ring 18 is fit over the outside circumference of the first end of (the large diameter section 3a of) magnetic tube member 3 to secure a liquid-tight connection between tube member 3 and the boss portion of the fuel pipe. A filter 21 is fit in the upstream end of tube member 3. Filter 21 includes a tubular portion 21a press-fit in the large diameter section of tube member 3; a frame portion 21b of a resin material, such as fluoroplastics, softer than the material of tube member 3, formed integrally with the tubular portion 21a (by injection molding, in this example); and a mesh element 21c installed in frame portion 21b and arranged to allow the fuel to pass through.

Core tube 5 is fit in magnetic tube member 3. Core tube 5 is a member to form a closed magnetic circuit for coil 15, with a valve element 9 and the yoke 13, and to define a valve open position of valve element 9. In this example, core tube 5 is installed in the small diameter section 3b of magnetic tube member 3 by press fitting.

A valve seat member 7 is a tubular member of a ferrous material such as stainless steel, installed in a downstream end portion of magnetic tube member 3. As shown in FIG. 2, valve seat member 7 includes a tubular portion 7a for receiving the valve element 9, a valve seat 7b in the form of a tapered or conical seat surface tapered toward the downstream end, and an opening portion 7c formed in the downstream end of valve seat 7. In the valve closing state, a valve portion 11 of the valve element 9 is seated on valve seat 7b. In the valve opening state, the valve seat 7b forms an annular fuel passage between the valve portion 11 of valve element 9 and the valve seat 7b surrounding the valve portion 11. Valve seat member 7 is fit forcibly in the small diameter section 3b of tube member 3 and fixed to magnetic tube member 3 by welding at a weld portion W extending entirely over the outer circumference of valve seat member 7. A nozzle member or plate 8 is fixed to the downstream end of valve seat member 7 by welding at a weld portion W so as to cover the opening portion 7c of valve seat member 7. Nozzle member 8 is formed with at least one nozzle hole 8a for injecting fuel from a predetermined position in a predetermined direction.

The valve element 9 is received in small diameter section 3b of magnetic tube member 3, between core tube 5 and valve seat member 7, and so arranged that valve element 9 can move in an axial direction between core tube 5 and valve seat member 7. Valve element 9 of this example includes an anchor portion 10 and a valve portion 11 which is fixed to the forward or downstream end of anchor portion 10 and which is arranged to abut on the valve seat 7b of valve seat member 7 and to move away from valve seat 7b. In this example, anchor portion 10 of valve element 9 is a stepped tubular member of ferrous metal material (ferrous material) extending axially. Valve portion 11 of this example is approximately spherical. Valve portion 11 includes an outer surface 11a which abuts on valve seat 7b in the valve closing state, and thereby forms a seal surface.

A coil spring 12 serves as biasing or urging device for urging the valve element 9 in the valve closing direction. Coil spring 12 is disposed under compression between core tube 5 and valve element 9. Coil spring 12 includes a first end which is inserted in an inside cavity 5a of core tube 5 and which abuts against a lower surface 19a of a tubular adjuster 19 fit in core tube 5; and a second end which is inserted in a depression 10a formed in an upper portion of anchor portion 10 of valve element 9, and which abuts against a bottom 10b of the depression 10a. Thus, coil spring 12 produces a resilient force extending axially. That is, coil spring 12 is used as a compression spring for pushing the valve element 9 in the valve closing direction to press the valve portion 11 against valve seat 7b.

The yoke 13 is a stepped tubular member mounted on magnetic tube member 3. In this example, yoke 13 is forcibly fit over the small diameter section 3b of tube member 3, and thereby fixedly mounted on the small diameter section 3b. A connection core 14 is provided between yoke 13 and the small diameter section 3b of tube member 3. In this example, connection core 14 is an approximately C-shaped magnetic member surrounding the small diameter section 3b of tube member 3. A resin cap 24 is fixed to a lower end portion of yoke 13, and arranged to define a groove for receiving an O-ring 22.

The electromagnetic coil 15 is disposed between the yoke 13 and magnetic tube member 3. Electromagnetic coil 15 includes a tubular bobbin 15a of resin material mounted on the small diameter section 3a of tube member 3; and a wire 15b wound around bobbin 15a. Electromagnetic coil 15 is energized through at least one pin 20 of a connector 17, and conductor 23 formed in a resin cover 16.

The resin cover 16 encloses the magnetic tube member 3. Resin cover 16 of this example is formed by an injection molding in the state of a subassembly of tube member 3 including yoke 13, connecting core 14 and magnetic coil 15 mounted on tube member 3. Resin cover 16 and connector 17 are integral parts of a single resin molding.

The thus-constructed fuel injector is held, by the urging force of coil spring 12, normally in the valve closing state when the electromagnetic coil 15 is not energized. In the valve closing state, the valve portion 11 of valve element 9 is seated on valve seat 7b. In this state, there is formed a clearance between the upper surface of anchor portion 10 and the lower surface of core tube 5.

When electromagnetic coil 15 is energized, the core tube 5, anchor portion 10 of valve element 9 and yoke 13 form a closed magnetic circuit producing, in the anchor portion 10, a magnetic force toward the core tube 5. Since the setting is such that the magnetic force (attraction force) becomes greater than the urging force of coil spring 12, the valve element 9 is attracted by the magnetic force against the urging force of coil spring 12, toward the core tube 5 away from the valve seat 7b, and the fuel injector is brought to the valve opening state.

In this valve opening state, the fuel introduced into the fuel injector 1 through filter 21 flows down a fuel passage 4 in the large diameter section 3a of magnetic tube member 3, and flows through the inside cavity of adjuster 19, the inside cavity 5a of core tube 5, the depressed portion 10a of anchor portion 10, and at least one through hole 9a formed in a side wall of valve element 9, into a back pressure chamber 6 in the form of an annular fuel passage surrounding valve element 9. From fuel chamber 6, the fuel flows through the gap or clearance formed between the valve portion 11 of valve element and the depressed portion 7a and the valve seat 7b of valve seat member 7, and gushes through the injection holes 8a of nozzle plate 8 (into the intake port, for example).

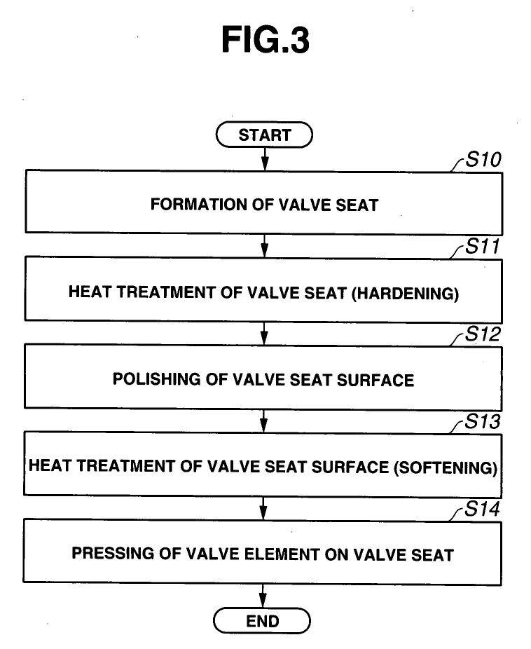

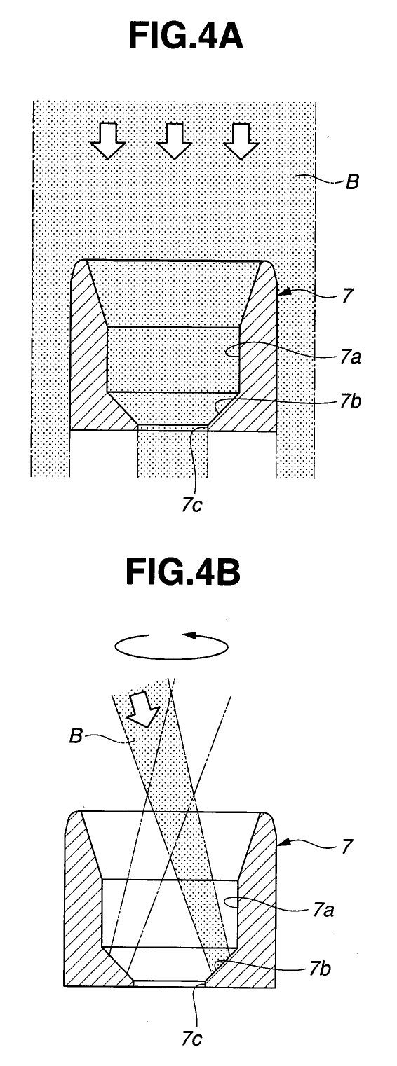

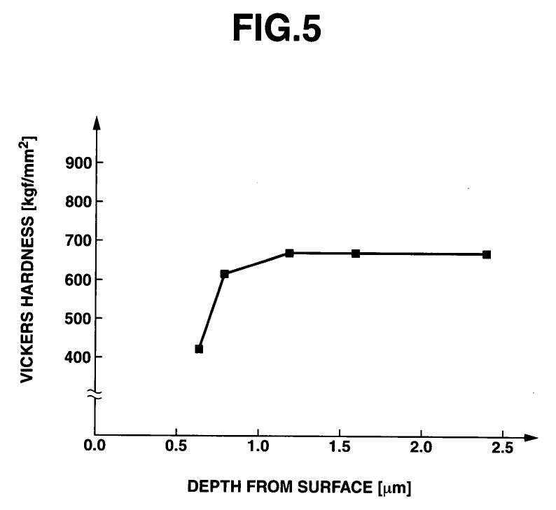

FIG. 3 shows a method of producing the fuel injector 1 and improving the sealing performance or capability between abutting portions of valve element 9 and valve seat 7b. FIGS. 4A and 4B schematically show an operation for softening the surface of valve seat member 7 by irradiation of beam such as electron beam or laser beam. FIG. 5 show the result of the softening operation in terms of the hardness with respect to the depth from the surface. In this example, the softening operation is performed at least to an abutting portion of the valve seat 7b of valve seat member 7, that is a region of valve seat 7b to form a seal surface with the valve portion 11.

The method of FIG. 3 includes a first step S10 of forming the valve seat member 7 by a metal forming operation such as grinding of a piece of raw material such as ferrous metal; and a second step S11 of hardening valve seat member 7 by heat treatment (such as quenching). The hardening heat treatment of step S11 is for improving the resistance against cyclic impact due to repetitive collisions between valve element 9 (outer surface 11a of valve portion 11) and valve seat member 7 (valve seat 7b) by the repetition of valve opening and closing operation. By this hardening operation, the hardness is increased to a required level (for example, about 700 [kgf/mm²] in terms of Vickers hardness) to a relatively great depth from the surface of valve seat 7b.

A third step S12 is a step of polishing the surface of valve seat 7b with grinding stone, for example. The polished region of valve seat 7b includes at least an abutting portion which abuts on the (outer surface 11a of) valve portion 11 of valve element 9, and forms a sealing surface with valve portion 11.

A fourth step S13 is a step of softening a surface layer of the abutting portion of valve seat 7b by heating the surface. In this example, the softening operation of step S13 is performed by irradiation of beam, such as electron beam or laser beam, onto the surface of valve seat member 7 with one of various irradiating apparatus for irradiating beam such as electron beam or laser beam. One example is an electron beam irradiating apparatus including an electron gun, a section for producing plasma in a region near anode and cathode electrode pair of the electron gun, and a section for causing collision of electrons, accelerating electrons and irradiating electrons to the valve seat member 7 as a target. Another example is an electron beam irradiating apparatus arranged to irradiate electron beam by emitting electrons by heating a cathode electrode with a filament, and accelerating the electrons with an anode electrode.

The electron beam irradiating apparatus of the former example can irradiate electron beam B onto a relatively wide region as shown in FIG. 4A at a time. Therefore, the operation of this example is easier since a wider area is processed by one operation. Moreover, it is possible to irradiate a target surface uniformly without causing overlap of electron beams.

The electron beam irradiating apparatus of the latter example can irradiate electron beam to the abutting portion of valve seat 7b by scanning a relatively narrow beam spot (in a rotational scanning motion in the example shown in FIG. 4B). The electron beam irradiating apparatus of this type can produce a stable electron beam B resistant to undesired influence from the ambient atmosphere, as compared to the former example, and hence reduce the nonuniformity (unit by unit or operation by operation). The number of times of scanning operations may be one or may be two or more according to the need.

As the laser beam irradiating apparatus, it is possible to employ various apparatus having different wavelengths such as CO² laser, YAG laser or excimer laser.

In any case, it is preferable to set the irradiation intensity of electron beam (or laser beam) at a level weaker than the level used for welding metal members.

By this softening operation, a surface layer having a depth of several micrometers from the surface is softened as shown in FIG. 5. In the example of FIG. 5, in the surface layer to a depth of 1.2 micrometer from the surface, the hardness is lower than the hardness of a deeper inner region. At the same time, the hardness of the surface layer is higher than the hardness of raw material before the heat treatment for hardening (higher than about 300 [kgf/mm²] in Vickers hardness in the case of ferrous material). The position, depth and hardness of the softened surface layer are determined appropriately in dependence on the shapes and materials of valve element 9 and valve seat member 7 and the biasing force of coil spring 12, by adjusting irradiating conditions of the electron beam or laser beam irradiating apparatus.

Then, the fuel injector 1 is assemble and connected with a drive circuit. Thus, fuel injector 1 is put in an operable state in which valve element 9 can be moved between the valve open position and the valve closed position. In this operable state, an operation for adapting the abutting portions of valve portions 11 (outer surface 11a) and valve seat 7b to fit each other is performed at a step S14, by repeating the opening and closing operation of valve element 9 by the application of pulsed control current to electromagnetic coil 15, and thereby pressing the valve portion 11 of valve element 9 onto the valve seat 7b of valve seat member 7 repeatedly. The number of repetitions is determined in accordance with the required level of the sealing performance, the shapes and materials of valve element 9 and valve seat member 7 and the biasing force of coil spring 12. The result of the investigation by the inventors of this application shows that the number of repetitions of the opening and closing operation of valve element 9 required to obtain a desired sealing capability can be reduced significantly by the interposition of the softening operation of step S13 of softening the surface layer of a sealing portion, as compared to the example in which the softening operation is not performed. For example, the number of repetitions of the opening and closing operation to obtain a desired sealing capability was at a level of 10⁷ when the softening operation is not performed, whereas the number of repetitions was reduced to a level of 10⁵ by the addition of the softening operation.

According to this embodiment, the softening operation is performed at step S13 by the heat treatment so as to form a softer surface layer in at least one of the abutting portions of valve element 9 and valve seat 7b (only the abutting portion of valve seat 7b in the illustrated example); and thereafter, the abutting portions of valve element 9 and valve seat 7b are pressed to each other so as to fit together. The softer surface layer having a lowered hardness is effective for improving the sealing capability between the abutting portions by adapting the abutting portions to fit each other. In the case of repeating the pressing operation between valve element 9 and valve seat 7b such as the valve opening and closing operation, it is possible to significantly reduce the number of repetitions required to achieve a desired sealing capability as compared to the earlier technology, and hence to reduce the production cost.

According to this embodiment, it is possible to improve the sealing capability by the adapting operation of adapting the abutting portions of valve element 9 and valve seat 7b to fit together after the assembly of the fuel injector 1. Therefore, even if strain is formed in valve element 9 or valve seat member 7 by welding, it is possible to restrain undesired influence from the strain.

In this embodiment, the adapting operation of step S14 is performed by repeating the valve opening and closing operation. Therefore, the adapting operation is achieved very easily. Moreover, by employing the irradiation of electron beam or laser beam as the heating operation in step S13, it is possible to obtain a softened state of appropriate position, depth, hardness and other conditions easily by setting and adjusting conditions of the irradiation.

The following are modifications and variations of the illustrated embodiment of the present invention capable of providing similar effects and operations. In the illustrated example, the softening operation is performed to soften only the valve seat. However, it is optional to soften the surface layer of the valve element or to soften both of the surface layers of the valve element and valve seat. Furthermore, the construction of the fuel injector is not limited to that shown in FIG. 1. The present invention is applicable to fuel injectors of various types having a valve element and a valve seat.

The addition of heat treatment for hardening an object portion before the heat treatment for softening the surface layer of the object portion is desirable. The softening heat treatment is performed to soften the surface layer of the object portion hardened by the hardening heat treatment. In this case, the object portion which is one of the abutting portions of the valve seat 7b and valve element 9 includes an inner region hardened by the hardening heat treatment, and the surface layer softened by the softening heat treatment. This structure including the harder inner region and the softer surface layer is effective for improving the strength of the valve seat and valve element against impact due to collision therebetween.

The addition of the polishing operation of step S12 for polishing the surface of the object portion before the softening heat treatment is desirable. The polishing operation for lowering the surface roughness of the surface to be softened is effective for improving the sealing performance by facilitating the operation for making the abutting portions to fit each other. Furthermore, the polishing operation helps the softening heat treatment lower the surface roughness by the softening heat treatment itself.

The operation for adapting the abutting portions to fit each other is preferably achieved by performing or repeating the valve opening and closing operation of the valve element. The employment of the valve opening and closing operation is effective for improving the sealing performance by reducing undesired influence due to strain caused by welding. Moreover, the valve opening and closing operation is easier to perform and effective for improving the sealing performance by conforming the portions actually forming the sealed interface.

The softening heat treatment is preferably applied to an object formed by grinding, and more specifically to the valve seat formed by grinding the valve seat member. With the softening operation and/or adapting operation for adapting the abutting portions to fit each other, it is possible to decrease the surface roughness resulting from the grinding operation, and thereby improve the sealing performance.

This application is based on a prior Japanese Patent Application No. 2006-071475 filed on Mar. 15, 2006. The entire contents of this Japanese Patent Application No. 2006-071475 are hereby incorporated by reference.

Although the invention has been described above by reference to certain embodiments of the invention, the invention is not limited to the embodiments described above. Modifications and variations of the embodiments described above will occur to those skilled in the art in light of the above teachings. The scope of the invention is defined with reference to the following claims.

What is claimed is:

1. A fuel injector comprising:
a valve seat member formed with a valve seat including an abutting portion; and
a valve element which is arranged to abut on the valve seat and move away from the valve seat, and which includes an abutting portion to abut on the abutting portion of the valve seat;
one of the abutting portions of the valve seat and the valve element including a surface layer softened by heating the surface layer, and pressed by abutment between the valve element and the valve seat to each other to make the abutting portions to fit each other.

2. The fuel injector as claimed in claim 1, wherein the surface layer of the one of the valve seat and the valve element is a surface layer softened by irradiation of beam.

3. The fuel injector as claimed in claim 2, wherein the one of the abutting portions of the valve seat and the valve element further includes an inner region which is formed under the surface layer and which is harder than the surface layer.

4. The fuel injector as claimed in claim 3, wherein the inner region is a region hardened by heat treatment and left un-softened under the surface layer.

5. The fuel injector as claimed in claim 2, wherein the one of the abutting portions of the valve seat and the valve element further includes a polished surface.

6. The fuel injector as claimed in claim 2, wherein the abutting portions of the valve seat and the valve element are formed by pressing the abutting portions to each other by performing an opening and closing operation of the valve element.

7. The fuel injector as claimed in claim 1, wherein the fuel injector further comprises a biasing device arranged to urge the valve element in a valve closing direction; and an electromagnetic coil arranged to move the valve element away from the valve seat when energized.

8. A production method of producing a fuel injector including a valve seat member which is formed with a valve seat including an abutting portion, and a valve element which is arranged to abut on the valve seat and to move away from the valve seat and which includes an abutting portion to abut on the abutting portion of the valve seat, the production method comprising:
softening a surface layer of one of the abutting portions of the valve seat and the valve element, by heating the surface layer; and
then, adapting the abutting portions of the valve seat and the valve element to fit each other by pressing the valve element and the valve seat to each other.

9. The production method as claimed in claim 8, wherein the abutting portions of the valve seat and the valve element are adapted to fit each other by performing an opening and closing operation of the valve element.

10. The production method as claimed in claim 8, wherein the surface layer is softened by irradiation of beam.

11. The production method as claimed in claim 8, wherein the production method further comprises: performing a heat treatment to harden the abutting portion having the surface layer to be softened, and the surface layer is softened after the heat treatment.

12. The production method as claimed in claim 8, wherein the production method further comprises polishing the surface layer before the surface layer is softened.

13. The production method as claimed in claim 8, wherein the production method comprises a first heat treatment of hardening an object portion which is one of the abutting portions of the valve seat and the valve element; and a second heat treatment of forming the surface layer softened by heating a surface of the object portion, and leaving an inner region hardened by the first heat treatment, un-softened under the surface layer.

14. The production method as claimed in claim 13, wherein the production method further comprises a treatment of polishing the surface of the object portion before the second heat treatment.

15. The production method as claimed in claim 14, wherein the treatment of polishing the surface of the object portion is performed after the first heat treatment.

16. The production method as claimed in claim 13, wherein the production method comprises an operation of forming the valve seat in the valve seat member; the first heat treatment comprises an operation of quenching the valve seat member; and the second heat treatment comprises irradiation of the beam which is one of electron beam and laser beam, to the valve seat.

17. The production method as claimed in claim 13, wherein the first heat treatment for hardening the object portion is adjusted to harden the object portion from a first hardness level to a second hardness level, and the second heat treatment is adjusted to soften the surface layer of the object portion from the second hardness level to a third hardness level which is lower than the second hardness level but higher than the first hardness level.

18. The production method as claimed in claim 13, wherein the object portion is made of ferrous material.
